(19) United States
(12) Patent Application Publication
(10) Pub. No.: US 2026/0234438 A1
(43) Pub. Date: Aug. 13, 2026

(54) COMPOSITIONS FOR FORMING POLYIMIDE COATINGS

(71) Applicant: HD MICROSYSTEMS, Wilmington, DE (US)

(72) Inventors: Fengxiang YOU, Garnet Valley, PA (US); R. Keith SANCLEMENTE, Middletown, DE (US); John Donald SUMMERS, Durham, NC (US)

(21) Appl. No.: 19/472,927

(22) PCT Filed: Apr. 2, 2024
(86) PCT No.: PCT/US2024/022612

§ 371 Date: Oct. 6, 2025

Related U.S. Application Data
(60) Provisional application No. 63/500,658, filed on May 8, 2023.

(51) Int. Cl. C09D 179/08; C08G 73/12; C08J 3/24; C08J 3/28

(52) U.S. Cl. CPC C09D 179/085; C08G 73/122; C08J 3/24; C08J 3/28; C08J 2379/08

(57) ABSTRACT

A composition and method effective for forming a polyimide film having a reduced dissipation factor and/or coefficient of thermal expansion. The composition includes a polyimide precursor and a select cross-linker. The cross-linker can have the formula: (R′)₂—C═C(R′)-L-[C(R′)═C(R′)₂]ₙ, where R′ is independently in each occurrence H or an alkyl of 1 to 3 carbon, L is a hydrocarbon group of 2 to 10 carbon atoms, L has the formula —C(═O)—(O)m-R″—, where R″ is an alkylene group of 1 to 6 carbon atoms, and m is 0 or 1, or L has the formula —R″′—O—R″′— where R″′ is independently in each occurrence an alkylene group of 1 to 6, carbon atoms, and n is 1, 2, or 3.

### CROSS-REFERENCE TO RELATED APPLICATIONS

This application claims the benefit of U.S. Provisional Application No. 63/500,658 filed May 8, 2023, the disclosure of which is incorporated herein by reference in its entirety.

### FIELD OF THE INVENTION

The field of the invention relates to photosensitive compositions useful in forming polyimide films.

### BACKGROUND OF THE INVENTION

Polyimide resins are useful in the electronics industry. For example, they can be used as insulation and/or passivation layer in the manufacture of integrated circuits. In these applications, the polyimide is located adjacent to other layers such as deposited metal.

Dissipation factor (DF) is a dimensionless (i.e., no units) measure of an electrical property of plastics and other electrical insulating materials. It is defined as the reciprocal of the ratio between the insulating materials' capacitive reactance and its resistance (Equivalent Series Resistance or ESR) at a specified frequency. In other words, it is defined as a ratio between the permittivity and the conductivity of an electrical insulating material. It measures the electrical energy absorbed and lost (power dissipation) when electrical current is applied to an insulating material. Dissipation factor indicates the inefficiency of material to hold energy or behave as an insulating material. The lower the dissipation factor, the more efficient is the insulator system. While polyimides generally have a relatively low dissipation factor (e.g., 0.01 to 0.02), polyimides having even lower dissipation factors are desired.

At the same time, since in certain electronics applications, a polyimide layer is adjacent to other layers and features such as deposited metal, metal vias, etc. the compatibility of the polyimide with those materials is important. One aspect of compatibility is how similar the materials are in regard to coefficient of thermal expansion (CTE). If the CTE's are significantly different, the device will undergo additional mechanical stresses when going through temperature changes (e.g., when heating occurs during use). The linear thermal expansion coefficient of metals is generally in the range of 3 to 20 parts per million (ppm)/degree Kelvin (or degree Celsius). For example, copper has a coefficient of linear thermal expansion (CLTE) at 20° C. of 17 parts per million (ppm)/degree Kelvin and a volumetric coefficient of expansion at 20° C. of 51 ppm/degree Kelvin. In contrast, polymers generally have a higher CTE.

It would be desirable to have a coating composition for making polyimide films that have a combination of both low dissipation factor and low CTE.

### SUMMARY OF THE INVENTION

Disclosed herein is a method of reducing a dissipation factor and coefficient of linear expansion of a film formed from a selected polyimide precursor comprising providing the selected the polyimide precursor wherein the polyimide precursor includes ethylenic unsaturation available for free radical reaction, combining the polyimide precursor with a cross-linker, a photoinitiator, and a solvent to form a coating composition, wherein the cross-linker has the formula: (R′)₂—C═C(R′)-L-[C(R′)═C(R′)₂]ₙ where R′ is independently in each occurrence H or an alkyl of 1 to 3 carbon, L is a hydrocarbon group of 2 to 10, preferably 2 to 8, more preferably 2 to 7, yet more preferably 2 to 6, carbon atoms, L has the formula —C(═O)—(O)ₘ—R″— where R″ is an alkylene group of 1 to 6, preferably 1 to 3, more preferably 1 or 2, carbon atoms, and m is 0 or 1, or L has the formula —R″′—O—R″′— where R″′ is independently in each occurrence an alkylene group of 1 to 6, preferably 1 to 3, more preferably 1 or 2 carbon atoms, and n is 1, 2, or 3, applying the coating composition to a substrate, drying to remove the solvent and form a solid coating, exposing the solid coating to activating wavelengths of radiation to react the cross-linker with the ethylenic unsaturation in the polyimide precursor, and curing to form the film.

Also disclosed herein is a coating composition comprising a polyimide precursor, a photoinitiator, a cross-linker, and a solvent, wherein the polyimide precursor includes ethylenic unsaturation available for free radical reaction and the cross-linker has the formula (R′)₂—C═C(R′)-L-C(R′)═C(R′)₂]ₙ where R′ is independently in each occurrence H or an alkyl of 1 to 3 carbon, and L is a linear or branched aliphatic hydrocarbon group of 2 to 7 carbon atoms L has the formula —C(═O)—O—R″— where R″ is an alkylene group of 1 to 6 carbon atoms, or L has the formula —R″—O—R″— where R″ is an alkylene group of 1 to 6 carbon atoms, and n is 1, 2, or 3.

Also disclosed herein is a coating composition comprising a polyimide precursor, photoinitiator, and a cross-linker, and a solvent, the polyimide precursor includes ethylenic unsaturation available for free radical reaction and wherein the cross-linker comprises a linking group, L, having not more than 5 atoms (excluding pendant atoms and pendant groups) covalently bonded between two ethylenically unsaturated groups wherein a polyimide film formed by steps comprising applying the composition to a substrate, drying to remove solvent to form a dried coating, exposing the dried coating to activating wavelengths of radiation to react the crosslinker with the polyimide precursor has a dissipation factor of no greater than 0.0074, preferably less than 0.007.

Also disclosed herein is a coating composition comprising a polyimide precursor, a photoinitiator, a cross-linker, and a solvent, wherein the polyimide precursor includes ethylenic unsaturation available for free radical reaction and wherein the cross-linker has the formula: (R′)₂—C═C(R′)-L-[C(R′)═C(R′)₂]ₙ where R′ is independently in each occurrence H or an alkyl of 1 to 3 carbon, and L is an alicyclic hydrocarbon of 5 to 7 carbons, preferably 6, and n is 1 or 2, wherein a polyimide film formed by steps comprising applying the composition to a substrate, drying to remove solvent to form a dried coating, exposing the dried coating to activating wavelengths of radiation to react the crosslinker with the polyimide precursor has a dissipation factor of less than 0.0074, preferably less than 0.007.

Also disclosed is an article made by applying such a coating composition to a substrate, drying to form a dried coating, exposing the coating to activating wavelengths of radiation and curing to form a polyimide film wherein the polyimide film is characterized by a dissipation factor of no greater than 0.0074, preferably less than 0.007, as determined by the Kent Method and a linear coefficient of thermal expansion of less than 52 ppm/degree Kelvin as determined by thermomechanical analysis.

### DETAILED DESCRIPTION OF THE INVENTION

The coating composition disclosed herein comprising a polyimide precursor with particular cross-linkers provides a polyimide with surprisingly good balance of low dissipation factor and low coefficient of thermal expansion.

### Polyimide Precursor

The polyimide precursor comprises a polyamic acid having functional groups that facilitate photoreaction. For example, the polyamic acid can be a polyamic acid ester including ethylenic unsaturation.

The polyamic acid can be one prepared from one or more dianhydride compounds and one or more diamine compounds. Derivatizing the polyamic acid with ethylenic unsaturation can provide or enhance photoreactivity.

The dianhydride compounds can comprise, for example 4,4′-bisphenol A diphthalic anhydride (BPADA), hydroquinone diphthalic anhydride (HQDA), oxydiphthalic anydride (ODPA), biphenyltetracarboxylic dianhydride (BPDA), bicyclo [2.2.2]oct-7-ene-2,3,5,6-tetracarboxylic dianhydride (BCODA), 4,4′-(Hexafluoroisopropylidene)diphthalic anhydride (6FDA), cyclobutanetetracarboxylic dianhydride (CBDA), p-Phenylene bis(trimellitate) dianhydride (TAHQ), 3-(Carboxymethyl)-1,2,4-cyclopentanetricarboxylic Acid 1,4:2,3-dianhydride (TCA-AH), or a combination of two or more thereof (e.g., a combination of two thereof or a combination of three thereof). As a more specific example, the dianhydride can comprise, consist essentially of, or consist of ODPA, BPDA or a combination thereof.

The diamine compound can comprise, for example, oxydianiline (ODA), 4-Dimethylaminopyridine (DMAP), 4,4′-(1,4-Phenylenediisopropylidene)bisaniline (Bis-P), 2,2-Bis [4-(4-aminophenoxy)phenyl]propane (BAPP), isophorone diamine IPDA), 4-aminophenyl sulfone (DDS), 2,2′-Bis(trifluoromethyl)benzidine (TFMB), 4,4′-methylenebis (2-methylcyclohexyl-amine) (DMDC), 4,4′-(1,3-Phenylenediisopropylidene)bisaniline (Bis-M), 1,3′-Bis (3-aminophenoxy) benzene (APB-133), p-phenylene diamine (PPD), or m-xylene diamine, or a combination of two or more thereof (e.g., a combination of two thereof or a combination of three thereof).

As more specific examples, the polyimide may be formed from ODPA and BAPP, or ODPA and Bis-P, or ODPA and DMAP, or BPDA and TFMB, or ODPA with both BAPP and DMAP, or both of ODPA and BPDA with DMAP, or both of ODPA and BPDA with both of DMAP and PPD.

To form a derivatized polyamic acid, an ethylenically unsaturated compound such as an acrylate or an ethylenically unsaturated alcohol can be reacted with the dianhydride or with a polyimide precursor formed from the dianhydride and the diamine. Examples of acrylates include hydroxyethylmethacrylate (HEMA), hydroxyproylmethacrylate (HPMA), and hydroxybutylmethacrylate (HBMA). An example of an ethylenically unsaturated alcohol can include those having 3 to 8, or 4 to 6 carbon atoms, such as, allyl alcohol or 4-penten-1-ol. For example, an acrylic such as HEMA can be reacted with the dianhydride to form a partially esterified compound.

U.S. Pat. No. 4,551,522 discloses examples how such a derivatized polyamic acid can be formed.

The polyimide precursor can comprise, for example, by repeat units represented by the formula (1)

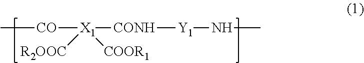

In the formula (1), X₁ is a tetravalent aromatic or alicyclic group, preferably aromatic, —COOR₁ group and —CONH— group are on ortho-position to each other, —COOR₂ group and —CO— group are on ortho-position to each other; Y₁ is a divalent aromatic or alicyclic group, preferably aromatic; R₁ and R₂ are independently a hydrogen atom, a group represented by the following formula (2) or (3), or an aliphatic hydrocarbon group having 1 to 4 carbon atoms, and at least one of R₁ and R₂ is a group represented by the formula (2) or (3).

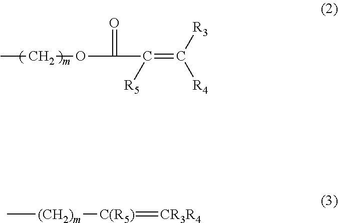

In the formula (2) and (3), R₃ to R₅ are independently a hydrogen atom or an aliphatic hydrocarbon group having 1 to 3 carbon atoms, and in is an integer of 1 to 10, preferably an integer of 2 to 5, more preferably 2 or 3.

The tetravalent aromatic group of the X₁ of the formula (1) may be a tetravalent aromatic hydrocarbon group or a tetravalent aromatic heterocyclic group. A tetravalent aromatic hydrocarbon group is preferred. Examples of the tetravalent aromatic hydrocarbon group of the X₁ of the formula (1) include, but are not limited to, a group represented by the following formula (4),

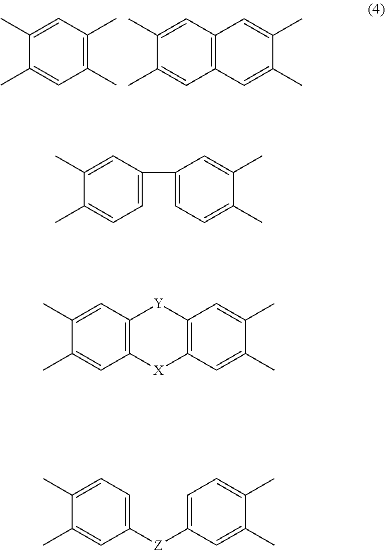

In the formula (4), X and Y independently represent a divalent group which is not conjugated to a benzene ring to which each is bonded, or a single bond; Z is an ether group (—O—) or a sulfide group (—S—) (—O— is preferable). In the formula (6), the divalent group of X and Y, which is not conjugated to the benzene ring to which each is bonded, is preferably —O—, —S—, a methylene group, a bis(trifluoromethyl)methylene group, or a difluoromethylene group, more preferably —O—.

The divalent aromatic group of the Y₁ of the formula (1) may be a divalent aromatic hydrocarbon group or a divalent aromatic heterocyclic group. A divalent aromatic hydrocarbon group is preferable. The divalent aromatic hydrocarbon group of the Y₁ of the formula (1) can include, but is not limited to, a group represented by the following formula (5).

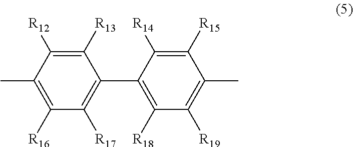

In the formula (5), R₁₂ to R₁₉ is independently a hydrogen atom, a monovalent aliphatic hydrocarbon group, or a monovalent organic group having a halogen atom.

Examples of the monovalent aliphatic hydrocarbon group (preferably having 1 to 10 carbon atoms, more preferably having 1 to 6 carbon atoms) of the R₁₂ to R₁₉ of the formula (5) include a methyl group and the like. For example, R₁₂ and R₁₅ to R₁₉ may be hydrogen atoms, and R₁₃ and R₁₄ may be monovalent aliphatic hydrocarbon groups. As the monovalent organic group having a halogen atom (preferably a fluorine atom) of the R₁₂ to R₁₉ of the formula (5), a monovalent aliphatic hydrocarbon group having a halogen atom (preferably having 1 to 10 carbon atoms, more preferably having 1 to 6 carbon atoms) is preferable, and a trifluoromethyl group and the like are mentioned.

The aliphatic hydrocarbon group having 1 to 4 carbon atoms (preferably 1 or 2) of the R₁ and R₂ of the formula (1) includes a methyl group, an ethyl group, an n-propyl group, a 2-propyl group, an n-butyl group, and the like.

At least one of R₁ and R₂ in the formula (1) is a group represented by the formula (2) or (3). The aliphatic hydrocarbon group having 1 to 3 carbon atoms (preferably 1 or 2) in the R₃ to R₅ of the formula (2) includes a methyl group, an ethyl group, an n-propyl group, a 2-propyl group, and the like. A methyl group is preferable.

The polyimide precursor having the structural unit represented by the formula (1) can be obtained by, for example, reacting a tetracarboxylic dianhydride represented by the following formula (6) and a diamino compound represented by the following formula (7) in an organic solvent such as N-methyl-2-pyrrolidone to obtain a polyamide acid, adding a compound represented by the following formula (8), and reacting in the organic solvent to partially introduce an ester group.

The tetracarboxylic dianhydride represented by the formula (6) and the diamino compound represented by the formula (7) may be used alone or in combination of two or more.

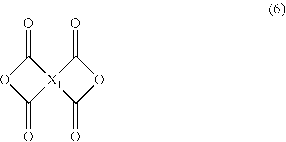

In the formula (6), X₁ is a group corresponding to the X₁ of the formula (1).

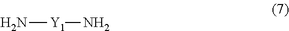

In the formula (7), Y₁ is as defined in the formula (1).

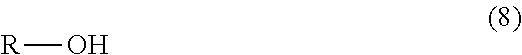

In the formula (8), R is a group represented by the formula (2).

The polyimide precursor may also comprise an additional repeat unit other than the repeat unit represented by the formula (1), e.g., to form a copolymer. Examples of the repeat unit other than the structural unit represented by the formula (1) include the structural unit represented by the following formula (9).

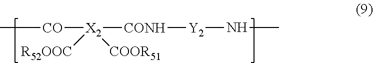

In the formula (9), X₂ is a tetravalent aromatic or alicyclic group, —COOR₅₁ group and —CONH— group are on ortho-position to each other, —COOR₅₂ group and —CO— group are on ortho-position to each other; Y₂ is a divalent aromatic or alicyclic group; and R₅₁ and R₅₂ are independently a hydrogen atom or an aliphatic hydrocarbon group having 1 to 4 carbon atoms. Examples of the tetravalent aromatic group of X₂ of the formula (9) include the same as the tetravalent aromatic group of X₁ of the formula (1). Examples of the divalent aromatic group of Y₂ of the formula (9) include the same as the divalent aromatic group of Y₁ of the formula (1). Examples of the aliphatic hydrocarbon group having 1 to 4 carbon atoms of R₅₁ and R₅₂ of the formula (9) include the same as the aliphatic hydrocarbon group having 1 to 4 carbon atoms of R₁ and R₂. The structural unit other than the structural unit represented by the formula (1) may be used alone or in combination of two or more.

The content of the repeat units other than the structural unit represented by the formula (1) is 0 to 99, 0 to 70, 30 to 70 or 40 to 60 mol %, based on all the repeat units of the polyimide precursor.

In the polyimide, the ratio of the carboxy group esterified with the group represented by the formula (2) to the total carboxy group and the total carboxy ester is preferably 50 mol % or more, more preferably 60 to 100 mol %, and still more preferably 70 to 90 mol %.

The molecular weight of the polyimide precursor is not particularly limited, but the number average molecular weight is preferably 10,000 to 200,000. The number average molecular weight can be measured by, for example, a gel permeation chromatography method, and can be calculated by conversion using a standard polystyrene calibration curve.

The polyimide precursor can be a blend of two or more polyimide precursor polymers as discussed above.

The polyimide precursor can be free of Si atoms. In addition, or alternatively, the polyimide precursor can be free of pendant groups of the structure —NHCOCN—X where x is a monovalent photosensitive group.

The polyimide precursor can be present in the coating composition in amounts of 20 to 60, or 30 to 50, weight percent based on total weight of the coating composition. The polyimide precursor can be present in the coating composition in an amount of 50 to 95, or 60 to 90, or 65 to 87 weight percent based on total weight of solids in the coating composition.

The coating composition can be free of other resins beside the polyimide precursor.

### Cross-Linker

The cross-linker comprises two or more (e.g., 2, 3, or 4) ethylenically unsaturated groups. The inventors have discovered that coating compositions having specific types of cross-linkers can surprisingly provide polyimide films having surprisingly lower the dissipation factor and lower coefficient of thermal expansion than other cross-linkers for the same polyimide precursor.

The cross-linkers effective in providing the combination of low dissipation factor and low coefficient of thermal expansion can comprise a linking group, L, between two ethylenically unsaturated group, where L comprises a short chain of covalently bonded atoms between any two ethylenically unsaturated groups and is free of a longer chain of atoms between any two ethylenically unsaturated groups. In determining chain length only atoms in the chain linking the ethylenically unsaturated groups are considered. Pendant atoms (e.g., hydrogen atoms on a carbon atom in the chain), and pendant groups, (e.g., a pendant methyl group from a carbon atom in the chain) are not considered.) Particularly, the cross-linkers disclosed herein comprise at least 1 but no more 5, preferably 2-4, and more preferably 3-4 atoms in the chain of linking group, L. The atoms in the chain can include, for example, carbon, oxygen or a combination of carbon atoms and an oxygen atom.

For example, the linking group, L, can be (i) a linear aliphatic hydrocarbon of 2 to 5 carbon atoms, can be an (ii) alicyclic hydrocarbon of 5 to 7 carbon atoms, or can have (iii) the structure

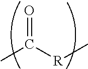

where R is a divalent hydrocarbon of 1-3 carbon atoms, —O—CH₂—, or —O—CH₂—CH₂—.

The cross-linkers effective in providing the combination of low dissipation factor and low coefficient of thermal expansion can have the formula the formula: (R′)₂—C═C(R′)-L-[C(R′)═C(R′)₂]ₙ where R′ is independently in each occurrence H or an alkyl of 1 to 3 carbon, L is a hydrocarbon group of 2 to 10, preferably 2 to 8, more preferably 2 to 7, yet more preferably 2 to 6, carbon atoms, L has the formula —C(═O)—(O)ₘ—R″— where R″ is an alkylene group of 1 to 6, preferably 1 to 3, more preferably 1 or 2, carbon atoms, and m is 0 or 1, or L has the formula —R″′—O—R″′— where R″′ is independently in each occurrence an alkylene group of 1 to 6, preferably 1 to 3, more preferably 1 or 2 carbon atoms, and n is 1, 2, or 3. L can be a linear or branched aliphatic hydrocarbon group of 2 to 7, preferably 2 to 6, carbon atoms, L has the formula —C(═O)—(O)ₘ—R″— where R″ is an alkylene group of 1 to 6, preferably 1 to 3, more preferably 1 or 1, and most preferably 1 carbon atoms, and m is 0 or 1, or L has the formula —R″′—O—R″′— where R″′ is independently in each occurrence an alkylene group of 1 to 6, preferably 1 to 3, more preferably 1 or 2 carbon atoms.

Preferably L is not an alkylene glycol or an alkylene glycol derivative.

Specific examples of cross-linkers that can be used with the polyimide precursor to provide polyimides with low dissipation factor and low CTE are allyl methacrylate and 1,2,4-trivinylcyclohexane.

The cross-linkers can be present in the coating composition in amounts of 1 to 50, 5 to 40, 10 to 35, 15 to 30 parts be weight per 100 parts by weight of the polyimide precursor.

The composition can be free of thermal cross-linkers such as 1,3-phenylenebisoxazoline or an epoxy resin.

### Solvent

The coating composition includes a solvent in which the polyimide precursor is dispersed or more preferably is in which the polyimide precursor is dissolved. Examples of such solvents include N-Methyl-2-pyrrolidone (NMP), tetrahydrofuran (THF), alcohol, such as methanol, acetone, toluene, acetophenone, propylene glycol, alkyl acetate, such as ethyl acetate, cyclopentanone, cyclohexanone, γ-butyrolactone, ethyl lactate, propylene glycol monomethyl ether acetate, benzyl acetate, n-butyl acetate, ethoxyethyl propionate, 3-methylmethoxypropionate, N,N-dimethylformamide, N,N-dimethylacetamide, dimethylsulfoxide, hexamethylphosphorylamide, tetramethylenesulfone, diethylketone, diisobutyl ketone, methylamyl ketone, N-dimethylmorpholine, and the like, or a combination of two or more thereof. Among them, 1-methyl-2-pyrrolidone, γ-butyrolactone, ethyl lactate, propylene glycol monomethyl ether acetate, N,N-dimethylformamide, and N,N-dimethylacetamide are preferably used from the viewpoint of excellent solubility of each component and applicability at the time of forming a photosensitive resin film.

As the solvent, as another example, a compound represented by the following formula (10) may be used.

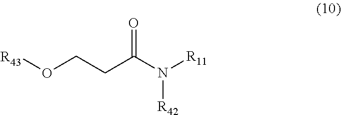

In the formula, R₄₁ to R₄₃ is independently an alkyl group having 1 to 10 carbon atoms.

Examples of the alkyl group having 1 to 10 (preferably 1 to 3, more preferably 1 or 3) carbon atoms of R₄₁ to R₄₃ in the formula (10) include a methyl group, an ethyl group, an n-propyl group, an isopropyl group, an n-butyl group, a t-butyl group, a pentyl group, a hexyl group, a heptyl group, an octyl group, and the like.

The amount of solvent can be selected to ensure other components are dissolved and to adjust for viscosity suitable for applying the coating. For example, the solvent can be present in an amount 30 to 80, or 30 to 60 weight percent based on total weight of the composition. As another example, the solvent can be present in amounts of 50 to 1000 parts by mass with respect to 100 parts by mass of the polyimide precursor.

### Photoinitiator

The coating composition can further include a photoinitiator. Examples of suitable photoinitiators include benzophenone derivatives such as benzophenone, methyl o-benzoylbenzoate, 4-benzoyl-4′-methyldiphenyl ketone, 1-[4-(Phenylthio)phenyl]-1,2-octanedione 2-(O-benzoyloxime), dibenzyl ketone, and fluorenone; acetophenone derivatives such as 2,2′-diethoxyacetophenone, 2-hydroxy-2-methylpropiophenone, and 1-hydroxycyclohexylphenyl ketone; thioxanthone derivatives such as thioxanthone, 2-methylthioxanthone, 2-isopropylthioxanthone, and diethylthioxanthone; benzyl derivatives such as benzyl, benzyl dimethyl ketal, and benzyl-p-methoxyethyl acetal; benzoin derivatives such as benzoin and benzoin methyl ether; and oxime esters such as 1-phenyl-1,2-butanedione-2-(o-methoxycarbonyl)oxime, 1-phenyl-1,2-propanedione-2-(o-methoxycarbonyl)oxime, 1-phenyl-1,2-propanedione-2-(o-ethoxycarbonyl)oxime, 1-phenyl-1,2-propanedione-2-(o-benzoyl)oxime, 1,3-diphenylpropanetrione-2-(o-ethoxycarbonyl)oxime, 1-phenyl-3-ethoxypropantrione-2-(o-benzoyl)oxime, ethanone, 1-[9-ethyl-6-(2-methylbenzoyl)-9H-carbazol-3-yl]-,1-(O-acetyloxime), the compound represented by the following compound, and the like.

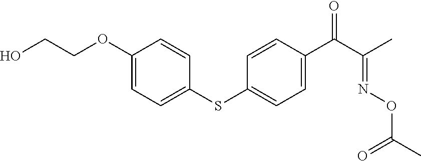 [SMILES: CC(=O)O/N=C(\C)C(=O)c1ccc(Sc2ccc(OCCO)cc2)cc1]

For example, the photo initiator can be 1-Phenyl-1,2-propanedione-2-(o-ethoxycarboxy)oxime.

The photoinitiator can be present in amounts of 0.1 to 20 parts by mass, more preferably from 0.1 to 10 parts by mass, and still more preferably from 0.1 to 5 parts by mass with respect to 100 parts by mass of the polyimide precursor.

### Additional Additives

The coating composition can further include additional additives such as inhibitor, sensitizer, adhesion promoters, or anti-corrosion additives.

An example of an inhibitor is 2,3-Diazabicyclo[3.2.2]non-2-ene,1,4,4-trimethyl-, 2,3-dioxide.

Examples of sensitizers include N,N,N′,N′-tetraethyl-4,4′-diaminobenzophenone, Michler's ketone, benzoin, 2-methylbenzoin, benzoinmethyl ether, benzoin ethyl ether, benzoin isopropyl ether, benzoin butyl ether, 2-t-butyl anthraquinone, 1,2-benzo-9,10-anthraquinone, anthraquinone, methylanthraquinone, 4,4′-bis-(diethylamino) benzophenone, acetophenone, benzophenone, thioxanthone, 1,5-acenaften, 2,2-dimethoxy-2-phenylacetophenone, 1-hydroxycyclohexylphenylketone, 2-methyl-[4-(Methylthio) phenyl]-2-morpholino-1-propanone, diacetylbenzyl, benzyldimethylketal, benzyldiethylketal, diphenyldisulfide, anthracene, phenanthrenequinone, riboflavintetrabutyrate, acridin orange, erythrosin, phenance renquinone, 2-isopropylthioxanthone, 2,6-bis (p-diethylaminobenziliden)-4-methyl-4-azacyclohexanone, 6-bis (p-dimethylaminobenziliden)-cyclopentanone, 2,6-bis (p-diethylaminobenzylene)-4-phenylcyclohexanone, aminostyryl ketone, 3-ketocoumarin compound, biscumarin compound, N-phenylglycine, N-phenyldiethanolamine, 3,3′, 4,4′-tetra (t-butylper) Oxycarbonyl) benzophenone and the like. The sensitizer may be used alone or in combination of two or more. When the photosensitive resin composition of the present disclosure contains a sensitizer, the blending amount of the sensitizer is preferably 0.1 part by mass to 1.0 part by mass, preferably 0.2 part by mass to 0.8 part by mass, with respect to 100 parts by mass of the polyimide precursor.

Examples of adhesion promoters include silane coupling agents, such as alkyl silane functional amine compounds including N-(Triethoxysilylpropyl) γ-aminopropyldimethoxysilane, N-(β-aminoethyl)-γ-aminopropylmethyldimethoxysilane, γ-glycidoxypropylmethyldimethoxysilane, γ-mercaptopropylmethyldimethoxysilane, 3-methacryloxypropyldimethoxymethylsilane, 3-methacryloxypropyltrimethoxysilane, dimethoxymethyl-3-piperidinopropylsilane, diethoxy-3-glycidoxypropylmethylsilane, N-(3-diethoxymethylsilylpropyl)succinimide, N-[3-(triethoxysilyl)propyl]phthalamide acid, benzophenone-3,3′-bis(N-[3-triethoxysilyl]propylamide)-4,4′-dicarboxylic acid, benzene-1,4-bis(N-[3-triethoxysilyl]propylamide)-2,5-dicarboxylic acid, 3-(triethoxysilyl)propylsuccinic anhydride, N-phenylaminopropyltrimethoxysilane, and N-phenyl-3-aminopropyltrimethoxysilane; or aluminum-based adhesion aids such as aluminumtris(ethyl acetoacetate), aluminumtris(acetyl acetoacetate), and ethylacetoacetate aluminum diisopropyrate. Of these adhesion aids, silane coupling agents are more preferably used in view of the adhesive strength. When the photosensitive resin composition includes the adhesion aid, the mixing amount is preferably within a range of 0.5 to 25 parts by mass based on 100 parts by mass of the polyimide precursor.

Examples of anti-corrosion additives include azole compounds such as 1H-triazole, 5-methyl-1H-triazole, 5-ethyl-1H-triazole, 4,5-dimethyl-1H-triazole, 5-phenyl-1H-triazole, 4-t-butyl-5-phenyl-1H-triazole, 5-hydroxyphenyl-1H-triazole, phenyltriazole, p-ethoxyphenyltriazole, 5-phenyl-1-(2-dimethylaminoethyl)triazole, 5-benzyl-1H-triazole, hydroxyphenyltriazole, 1,5-dimethyltriazole, 4,5-diethyl-1H-triazole, 1H-benzotriazole, 2-(5-methyl-2-hydroxyphenyl)benzotriazole, 2-[2-hydroxy-3,5-bis(a,a-dimethylbenzyl)phenyl]-benzotriazole, 2-(3,5-di-t-butyl-2-hydroxyphenyl)benzotriazole, 2-(3-t-butyl-5-methyl-2-hydroxyphenyl)-benzotriazole, 2-(3,5-di-t-amyl-2-hydroxyphenyl)benzotriazole, 2-(2′-hydroxy-5′-t-octylphenyl)benzotriazole, hydroxyphenylbenzotriazole, tolyltriazole, 5-methyl-1H-benzotriazole, 4-methyl-1H-benzotriazole, 4-carboxy-1H-benzotriazole, 5-carboxy-1H-benzotriazole, 1H-tetrazole, 5-methyl-1H-tetrazole, 5-phenyl-1H-tetrazole, 5-amino-1H-tetrazole, and 1-methyl-1H-tetrazole. One or more selected from tolyltriazole, 5-methyl-1H-benzotriazole, and 4-methyl-1H-benzotriazole are particularly preferable. These azole compounds may be used alone, or a mixture of two or more thereof may be used. When the photosensitive resin composition of the present disclosure contains anti-corrosion additives, the content of anti-corrosion additives is preferably 0.01 to 10, more preferably 0.5 to 5, yet more preferably 1 to 3 parts by mass with respect to 100 parts by mass of the polyimide precursor.

These additional additives can be present in amounts of from 0 or from 0.15 up to less than 5, less than 3, less than 2 or less than 1 wt % based on total weight of the coating composition.

The coating composition can be free of ammonium salts.

### Method

The coating composition as disclosed herein can be coated on a substrate such as a silicon wafer (with or without features such as metal layers and the like) and dried. The coating composition can then be exposed to activating wavelengths of radiation to cross-link the polyimide precursor. The exposure to radiation may be in a pattern such as through a mask or by laser addressing of the coating. The unexposed portions can then be removed with solvent. The remaining x-linked portions are cured to form the polyimide.

### Polyimide

The resulting polyimide film can have a thickness of, for example, 3 to 15 microns.

The resulting polyimide film can have a dissipation factor of no greater than 0.0074, or less than 0.0074, and preferably less than 0.007. The dissipation factor can be at least 0.002. The dissipation factor can be measured by a vector network analyzer, such as a Rohde & Schwarz ZNB40 VNA at 18 Herz. The dissipation factor can be determined by the Kent Method (See, e.g., Nondestructive Permittivity Measurement of Substrates, Gordon Kent, IEEE Transactions of Instrumentation and Measurement, Vol. 45, No. 1, February 1996.)

The resulting polyimide film can have a linear coefficient of thermal expansion (CTE) of less than 52, less than 51.5, less than 51, or no greater than 50.5 parts per million/degree Kelvin as measured by thermomechanical analysis using a thermomechanical analyzer, such as, for example, Hitachi™ TMA7100 at temperatures of from 70 to 120° C. The CTE of the polyimide film can be at least 15, at least 20, greater than 30, greater than 31, greater than 32, greater than 33, greater than 34, or greater than 35 parts per million/degree Kelvin.

### EXAMPLES

### A. Polyimide Precursor Preparation:

The synthesis of the photosensitive polyamic acid ester precursors can be prepared by reacting dianhydride, diamine and ethylenic unsaturated group for reaction with the cross-linker using the method described herein or as described in U.S. Pat. No. 4,551,522.

### B. Evaluation of Lithographic Performance:

Photosensitive negative-tone PI compositions are coated on 4-inch silicon wafers by a spin coater at 10 μm thickness after cure. The coated wafers are soft-baked on a hot plate at 90° C. for 2 minutes followed by 110° C. for 2 minutes. The coated films are exposed through a mask using AOI exposure unit and developed with cyclopentanone. Then the wafers are cured at a given temperature to form polyimide. The resolution of the resulting patterns is measured by using an optical microscope.

### C. Measurement of Dissipation Factor, Df:

Photosensitive negative-tone PI compositions are coated on a 6-inch silicon wafer by a spin coater at 10 μm thickness after cure. The coated wafers are soft-baked on a hot plate at 90° C. for 2 minutes followed by 110° C. for 2 minutes. 400 mJ/cm2 UV is exposed. Then, the wafer is cured at 280° C. for 2 hours under N2 flow. Polyimide films are removed from the wafers. Df is measured by using the cured film by Rohde & Schwarz ZNB40 VNA (vector network analyzer) at 18 GHz.

### D. Measurement of CTE (Coefficient of Thermal Expansion)

Linear CTE was determined by TMA with Hitachi TMA7100. The data reported is between 70° C.-120° C.

### Examples 1-17

### Preparation of Photosensitive Coating Composition

Preparation of photosensitive composition are prepared by mixing polyimide precursor, crosslinker, photo initiator and other additives in solvent as set out in Table 1.

TABLE 1

| | | Parts by |
|---|---|---|
| Ingredient | Name | weight |
| Solvent | 1-Methyl-2-pyrrolidinone | 130 |
| Inhibitor | 2,3- | 0.3 |
| | Diazabicyclo[3.2.2]non-2- | |
| | ene, 1,4,4-trimethyl-, 2,3- | |
| | dioxide | |
| Polyimide | | 100 |
| precursor | | |
| Crosslinker | | 20 |
| Photo | Oxime photoinitiator 1 | 9 |
| initiator | | |
| Photo | N,N,N′,N′-Tetraethyl-4,4′- | 1 |
| sensitizer | diaminobenzophenone | |
| Anti-rust | Benzotriazole | 2 |
| Adhesion | N- | 6 |
| promoter | (Triethoxysilylpropyl)urea | |
| | in methanol (50%) | |

Coating formulations were prepared as described above from a polyimide precursor which is a polyimide partially esterified with an acrylate and the cross-linker set forth in Table 2. These samples were tested as described above for dissipation factor (Df) and CTE in parts per million per degree Kelvin as described above. The results are shown in Table 2.

TABLE 2

| Example # | Name | Crosslinker Structure | Df | CTE |
|---|---|---|---|---|
| 1 (Com- parative) | 1,12 Dodecanediol dimethacrylate | 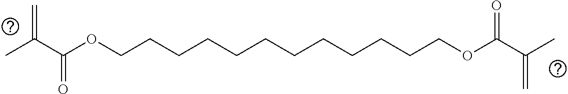 [SMILES: C=C(C)C(=O)OCCCCCCCCCCCCOC(=O)C(=C)C] | 0.00544 | 61.6 |
| 2 (Com- parative) | 1,6-Hexanediol dimethacrylate | 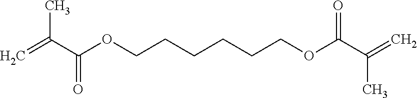 [SMILES: C=C(C)C(=O)OCCCCCCOC(=O)C(=C)C] | 0.00666 | 52.4 |
| 3 (Com- parative) | 1,4-Butanediol dimethacrylate | 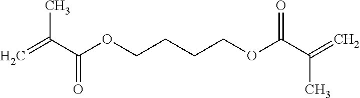 [SMILES: C=C(C)C(=O)OCCCCOC(=O)C(=C)C] | 0.007246 | 52.8 |
| 4 | Allyl Methacrylate (AMA) | 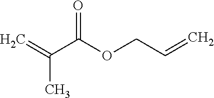 | 0.00670 | 50.4 |
| 5 | 1,2,4 trivinyl- cyclohexane (TVCH) | 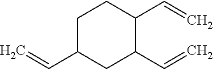 | 0.00699 | 50.5 |
| 6 (Com- parative) | Ethylene Glycol Dimethacrylate | 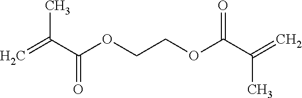 | 0.00743 | 50.2 |
| 7 (Com- parative) | glyoxal bis (dially acetal) | 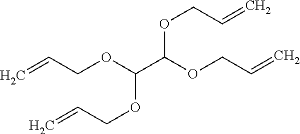 [SMILES: C=CCOC(OCC=C)C(OCC=C)OCC=C] | 0.00743 | 52.5 |
| 8 (Com- parative) | 1,4 cyclohexane dimethanol divinyl ether | 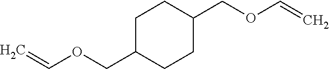 | 0.00756 | 54.2 |
| 9 (Com- parative) | 1,4-Butanediol diacrylate | 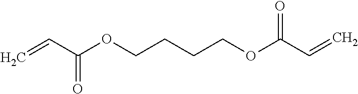 | 0.00796 | 53.2 |
| 10 (Com- parative) | 3,9-divinylspirobi (m-dioxane) | 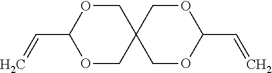 | 0.00807 | 51.2 |
| 11 (Com- parative) | tripropylene glycol diacrylate (TIEGDA) | 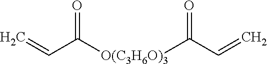 | 0.00904 | 56.8 |
| 12 (Com- parative) | Tricyclo [5.2.1.02,6] decane- dimethanol diacrylate | 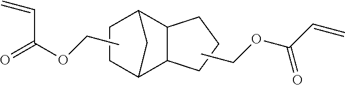 | 0.00965 | 54.3 |
| 13 (Com- parative) | Tris(2- acryloyloxyethyl) Isocyanurate | 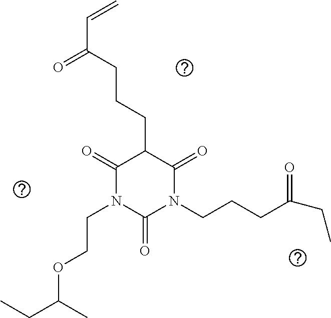 [SMILES: C=CC(=O)CCCC1C(=O)N(CCCC(=O)CC)C(=O)N(CCOC(C)CC)C1=O] [symbol] | 0.01006 | 51.6 |
| 14 (Com- parative) | Tetramethylol methane tetraacrylate | 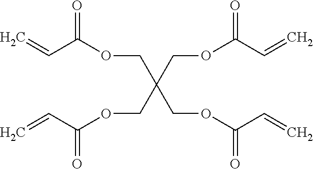 [SMILES: C=CC(=O)OCC(COC(=O)C=C)(COC(=O)C=C)COC(=O)C=C] | 0.01180 | 52.2 |
| 15 (Com- parative) | Dipentaerythritol penta-/hexa- acrylate | 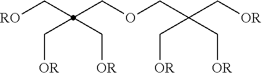 R = H or 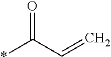 [SMILES: *C(=O)C=C] | 0.01283 | 55.4 |
| 16 (Com- parative) | TEGDMA | 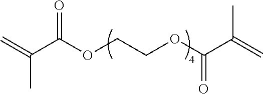 | 0.01532 | 57.9 |
| 17 (Com- parative) | polyethylene glycol (400) diacrylate (PEGDA) | 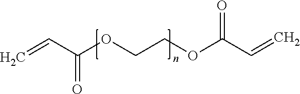 | 0.03433 | 90.7 |

[symbol]

indicates data missing or illegible when filed

Examples 4 and 5 show a better combination of low dissipation and low CTE than do the comparative examples.

### Example 18

Various polyimide precursors functionalized with hydroxyethylmethacrylate were tested in combination with the cross linkers AMA, TVCH, TEGDMA, and PEGDA. The coating compositions were prepared substantially as in Table 1 except a different oxime photoinitiator was used.

Polyimide precursor A is based on ODPA and BAPP, Polyimide precursor B is based on ODPA and Bis-P. Polyimide precursor C is based on BPDA and TFMB. Polyimide D is a reaction product of two dianhydrides reacted with two diamines.

The results as shown in Table 3 show that the AMA and TVCH provide lower dissipation factor with each polyimide precursor.

TABLE 3

| Polymer | Crosslinker | Df |
|---|---|---|
| A | TEGDMA | 0.01409 |
| A | TVCH | 0.00633 |
| A | AMA | 0.00657 |
| A | PEGDA | 0.01709 |
| B | TEGDMA | 0.01434 |
| B | TVCH | 0.00731 |
| B | AMA | 0.00740 |
| B | PEGDA | 0.01819 |
| C | TVCH | 0.00626 |
| C | PEGDA | 0.01652 |
| D | AMA/TVCH | 0.00697 |
| D | TEGDMA | 0.01682 |

### Example 19

Various functionalizing groups were tested on a polyimide precursor as shown in Table 4. See results below:

TABLE 4

| Ethylenically unsaturated | | |
|---|---|---|
| compound | Crosslinker | Df |
| hydroxyethylmethacrylate | AMA | 0.00670 |
| Hydroxypropyl methacrylate | AMA | 0.00613 |
| 4-Hydroxybutyl acrylate | AMA | 0.00682 |
| 4-penten-1-ol | AMA | 0.00700 |

### Example 20

A formulation as in Example 4 and a formulation as in Comparative 16 Example 16, were tested for lithographic performance as described above. The formulation as in Example 4 had a resolution of 5 micrometers which the formulation as in comparative Example 16 had a resolution of 7 micrometers.

This disclosure further encompasses the following aspects.

Aspect 1: A method of reducing a dissipation factor and coefficient of linear expansion of a film formed from a selected polyimide precursor comprising providing the selected the polyimide precursor wherein the polyimide precursor includes ethylenic unsaturation available for free radical reaction, combining the polyimide precursor with a cross-linker, a photoinitiator, and a solvent to form a coating composition, wherein the cross-linker has the formula: (R′)₂—C═C(R′)-L-[C(R′)═C(R′)₂]ₙ where R′ is independently in each occurrence H or an alkyl of 1 to 3 carbon, L is a hydrocarbon group of 2 to 10, preferably 2 to 8, more preferably 2 to 7, yet more preferably 2 to 6, carbon atoms, L has the formula —C(═O)—(O)ₘ—R″— where R″ is an alkylene group of 1 to 6, preferably 1 to 3, more preferably 1 or 2, carbon atoms, and m is 0 or 1, or L has the formula —R″′—O—R″′— where R″′ is independently in each occurrence an alkylene group of 1 to 6, preferably 1 to 3, more preferably 1 or 2 carbon atoms, and n is 1, 2, or 3, applying the coating composition to a substrate, drying to remove the solvent and form a solid coating, exposing the solid coating to activating wavelengths of radiation to react the cross-linker with the ethylenic unsaturation in the polyimide precursor, and curing to form the film.

Aspect 2: The method of Aspect 1 wherein L comprises an aliphatic hydrocarbon group of 2 to 6, preferably 2 to 5 carbon atoms, L has the formula —C(═O)—O—R″— where R″ is an alkylene group of 1 to 6 carbon atoms, or L has the formula —R″—O—R″— where R″ is an alkylene group of 1 to 6 carbon atoms, and n is 1.

Aspect 3: The method of Aspect 1 wherein L comprises an alicyclic hydrocarbon of 5 to 7, preferably 6, carbons and n is 1 or 2.

Aspect 4: The method of Aspect 1 wherein the crosslinker comprises ally methacrylate, 1,2,4-trivinylcyclohexane, or a combination thereof.

Aspect 5: The method of any of the previous Aspects wherein the film has a dissipation factor of no greater than 0.0074, preferably no greater than 0.007, more preferably less than 0.007.

Aspect 6: The method of any of the previous Aspects wherein the film has a linear coefficient of thermal expansion of less than 52, preferably less than 51 ppm/degree Kelvin.

Aspect 7: A coating composition comprising a polyimide precursor, a photoinitiator, a cross-linker, and a solvent, wherein the polyimide precursor includes ethylenic unsaturation available for free radical reaction and the cross-linker has the formula (R′)₂—C═C(R′)-L-C(R′)═C(R′)₂]ₙ where R′ is independently in each occurrence H or an alkyl of 1 to 3 carbon, and L is a linear or branched aliphatic hydrocarbon group of 2 to 7 carbon atoms L has the formula —C(═O)—O—R″— where R″ is an alkylene group of 1 to 6 carbon atoms, or L has the formula —R″—O—R″— where R″ is an alkylene group of 1 to 6 carbon atoms, and n is 1, 2, or 3.

Aspect 8: A coating composition comprising a polyimide precursor, photoinitiator, and a cross-linker, and a solvent, the polyimide precursor includes ethylenic unsaturation available for free radical reaction and wherein the cross-linker comprises a linking group, L, having not more than 5 atoms (excluding pendant atoms and pendant groups) covalently bonded between two ethylenically unsaturated groups wherein a polyimide film formed by steps comprising applying the composition to a substrate, drying to remove solvent to form a dried coating, exposing the dried coating to activating wavelengths of radiation to react the crosslinker with the polyimide precursor has a dissipation factor of less than 0.0074, preferably less than 0.007.

Aspect 9: The coating composition of Aspect 8 wherein the linking group, L, is a linear aliphatic hydrocarbon of 2 to 5 carbon atoms, alicyclic hydrocarbon of 5 to 7 carbon atoms, or has the structure

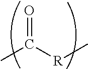

where R divalent hydrocarbon of 1-3 carbon atoms, —O—CH₂—, or —O—CH₂—CH₂—.

Aspect 10: The coating composition of claim 8 wherein the cross-linker comprises 1,2,4-trivinylcyclohexane, allyl methacrylate, or a combination thereof.

Aspect 11: A coating composition comprising a polyimide precursor, a photoinitiator, a cross-linker, and a solvent, wherein the polyimide precursor includes ethylenic unsaturation available for free radical reaction and wherein the cross-linker has the formula: (R′)₂—C═C(R′)-L-[C(R′)═C(R′)₂]ₙ where R′ is independently in each occurrence H or an alkyl of 1 to 3 carbon, and L is an alicyclic hydrocarbon of 5 to 7 carbons, preferably 6, and n is 1 or 2, wherein a polyimide film formed by steps comprising applying the composition to a substrate, drying to remove solvent to form a dried coating, exposing the dried coating to activating wavelengths of radiation to react the crosslinker with the polyimide precursor has a dissipation factor of less than 0.0074, preferably less than 0.007.

Aspect 12: The method according to any one of Aspects 1-6 or the coating composition of any one of Aspects 7-11 wherein the polyimide precursor comprises a polyamic acid, polyamic acid ester, or a combination thereof.

Aspect 13: The method according to any one of Aspects 1-6 or the coating composition of any one of Aspects 7-11 wherein the polyimide precursor comprises repeat units formed from reaction of dianhydride monomers comprising 4,4′-bisphenol A diphthalic anhydride, hydroquinone diphthalic anhydride, oxydiphthalic anydride, biphenyltetracarboxylic dianhydride, bicyclo [2.2.2]oct-7-ene-2,3,5,6-tetracarboxylic dianhydride, 4,4′-(Hexafluoroisopropylidene)diphthalic anhydride, cyclobutanetetracarboxylic dianhydride, p-Phenylene bis(trimellitate) dianhydride, 2,3,5-tricarboxycyclopentylacetic acid-1,4:2,3-dianhydride, or a combination of two or more thereof.

Aspect 14: The method according to any one of Aspects 1-6 or the coating composition of any one of Aspects 7 to 13 wherein polyimide precursor comprises repeat units formed from diamine monomers selected from oxydianiline, 4-Dimethylaminopyridine, 4,4′-(1,4-phenylenediisopropylidene)bisaniline, 2,2-Bis [4-(4-aminophenoxy)phenyl]propane, isophorone diamine, 4-aminophenyl sulfone, 2,2′-Bis(trifluoromethyl)benzidine, 4,4′-methylenebis (2-methylcyclohexyl-amine), 4,4′-(1,3-Phenylenediisopropylidene)bisaniline, 1,3′-Bis (3-aminophenoxy) benzene, p-phenylene diamine, or m-xylene diamine, or a combination of two or more thereof.

Aspect 15: The method according to any one of Aspects 1-6 or the coating composition of any one of Aspects 7-11 wherein the polyimide precursor comprises repeat units of the formula (1)

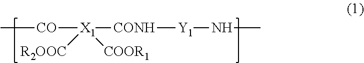

wherein, X₁ is a tetravalent aromatic or alicyclic group, preferably aromatic, —COOR₁ group and —CONH— group are on ortho-position to each other, —CCOOR₂ group and —CO— group are on ortho-position to each other; Y₁ is a divalent aromatic or alicyclic group, preferably aromatic; R₁ and R₂ are independently a hydrogen atom, a group represented by the following formula (2) or (3), or an aliphatic hydrocarbon group having 1 to 4 carbon atoms, and at least one of R₁ and R₂ is a group represented by the formula (2) or (3)

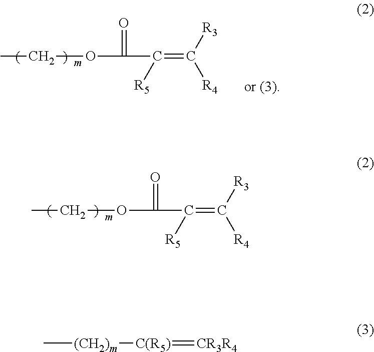

wherein, R₃ to R₅ is independently a hydrogen atom or an aliphatic hydrocarbon group having 1 to 3 carbon atoms, and m is an integer of 1 to 10, preferably an integer of 2 to 5, more preferably 2 or 3.

Aspect 16: The method according to any one of Aspects 1-6 or the coating composition of any one of Aspects 7-14 wherein the polyimide precursor is partially esterified with an ethylenically unsaturated compound, preferably an ethylenically unsaturated alcohol (preferably having 3 to 8, more preferably 4 to 6 carbon atoms), or a hydroxyalkyl (meth)acrylate, more preferably hydroxyethylmethacrylate (HEMA), hydroxyproylmethacrylate (HPMA), hydroxybutylmethacrylate (HBMA), or 4-penten-1-ol.

Aspect 17: The coating composition of any of Aspects 7 to 16 further comprising one or more of a photo-sensitizer, an anti-corrosion agent, an inhibitor, and an adhesion promoter.

Aspect 18: A method comprising applying a coating composition of any one of Aspects 7 to 17 to a substrate, drying to form a dried coating, exposing the coating to activating wavelengths of radiation and curing to form a polyimide film.

Aspect 19: The method of Aspect 18 wherein the exposing to activating wavelengths of radiation is done in an imagewise manner and unexposed portions are removed prior to curing.

Aspect 20: An article made by the method of any one of Aspects 18-19 wherein the polyimide film is characterized by a dissipation factor of no greater than 0.0074, preferably less than 0.007, as determined by the Kent Method and a linear coefficient of thermal expansion of less than 52 ppm/degree Kelvin as determined by thermomechanical analysis.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). Moreover, stated upper and lower limits can be combined to form ranges (e.g., “at least 1 or at least 2 weight percent” and “up to 10 or 5 weight percent” can be combined as the ranges “1 to 10 weight percent”, or “1 to 5 weight percent” or “2 to 10 weight percent” or “2 to 5 weight percent”).

The disclosure may alternately comprise, consist of, or consist essentially of, any appropriate components herein disclosed. The disclosure may additionally, or alternatively, be formulated so as to be devoid, or substantially free, of any components, materials, ingredients, adjuvants or species used in the prior art compositions or that are otherwise not necessary to the achievement of the function and/or objectives of the present disclosure.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

Unless specified to the contrary herein, all test standards are the most recent standard in effect as of the filing date of this application, or, if priority is claimed, the filing date of the earliest priority application in which the test standard appears.

1.-35. (canceled)

36. A coating composition comprising a polyimide precursor, a photoinitiator, a cross-linker, and a solvent, wherein the polyimide precursor includes ethylenic unsaturation available for free radical reaction and the cross-linker has the formula: (R′)₂—C═C(R′)-L-[C(R′)═C(R′)₂]ₙ
where R′ is independently in each occurrence H or an alkyl of 1 to 3 carbon, and
L is a linear or branched aliphatic hydrocarbon group of 2 to 7 carbon atoms
L has the formula —C(═O)—O—R″— where R″ is an alkylene group of 1 to 6 carbon atoms, or
L has the formula —R″—O—R″— where R″ is an alkylene group of 1 to 6 carbon atoms, and
n is 1, 2, or 3.

37. A coating composition comprising a polyimide precursor, photoinitiator, and a cross-linker, and a solvent, the polyimide precursor includes ethylenic unsaturation available for free radical reaction and wherein the cross-linker comprises a linking group, L, having not more than 5 atoms (excluding pendant atoms and pendant groups) covalently bonded between two ethylenically unsaturated groups wherein a polyimide film formed by steps comprising applying the composition to a substrate, drying to remove solvent to form a dried coating, exposing the dried coating to activating wavelengths of radiation to react the crosslinker with the polyimide precursor has a dissipation factor of less than 0.0074.

38. The coating composition of claim 36 wherein the linking group, L, is a linear aliphatic hydrocarbon of 2 to 5 carbon atoms, alicyclic hydrocarbon of 5 to 7 carbon atoms, or has the structure 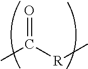
where R divalent hydrocarbon of 1-3 carbon atoms, —O—CH₂—, or —O—CH₂—CH₂—.

39. The coating composition of claim 36 wherein the cross-linker comprises 1,2,4-trivinylcyclohexane, allyl methacrylate, or a combination thereof.

40. The coating composition of claim 36 wherein the polyimide precursor comprises a polyamic acid, polyamic acid ester, or a combination thereof.

41. The coating composition of claim 36 wherein the polyimide precursor comprises repeat units formed from reaction of dianhydride monomers with amine monomers wherein the dianhydride monomers are selected from 4,4′-bisphenol A diphthalic anhydride, hydroquinone diphthalic anhydride, oxydiphthalic anydride, biphenyltetracarboxylic dianhydride, bicyclo [2.2.2]oct-7-ene-2,3,5,6-tetracarboxylic dianhydride, 4,4′-(Hexafluoroisopropylidene)diphthalic anhydride, cyclobutanetetracarboxylic dianhydride, p-Phenylene bis(trimellitate) dianhydride, 2,3,5-tricarboxycyclopentylacetic acid-1,4:2,3-dianhydride, or a combination of two or more thereof.

42. The coating composition of claim 41 wherein the diamine monomers are selected from oxydianiline, 4-Dimethylaminopyridine, 4,4′-(1,4-phenylenediisopropylidene)bisaniline, 2,2-Bis [4-(4-aminophenoxy)phenyl]propane, isophorone diamine, 4-aminophenyl sulfone, 2,2′-Bis(trifluoromethyl)benzidine, 4,4′-methylenebis (2-methylcyclohexyl-amine), 4,4′-(1,3-Phenylenediisopropylidene)bisaniline, 1,3′-Bis (3-aminophenoxy) benzene, p-phenylene diamine, or m-xylene diamine, or a combination of two or more thereof.

43. The coating composition of claim 40 wherein the polyimide precursor is partially esterified with an ethylenically unsaturated compound, preferably hydroxyethylmethacrylate, hydroxyproylmethacrylate, hydroxybutylmethacrylate, or 4-penten-1-01.

44. The coating composition of claim 36 further comprising one or more of a photo-sensitizer, an anti-corrosion agent, an inhibitor, and an adhesion promoter.

45. A method comprising
providing a polyimide precursor wherein the polyimide precursor includes ethylenic unsaturation available for free radical reaction,
combining the polyimide precursor with a cross-linker, a photoinitiator, and a solvent to form a coating composition, wherein the cross-linker has the formula: 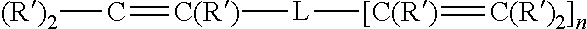
where R′ is independently in each occurrence H or an alkyl of 1 to 3 carbon,
L is a hydrocarbon group of 2 to 10 carbon atoms, L has the formula —C(═O)—(O)ₘ—R″— where R″ is an alkylene group of 1 to 6 carbon atoms, and m is 0 or 1, or L has the formula —R″′—O—R″′— where R″′ is independently in each occurrence an alkylene group of 1 to 6 carbon atoms, and
n is 1, 2, or 3,
applying the coating composition to a substrate,
drying to remove the solvent and form a solid coating,
exposing the solid coating to activating wavelengths of radiation to react the cross-linker with the ethylenic unsaturation in the polyimide precursor, and
curing to form the film.

46. The method of claim 45 wherein the crosslinker comprises ally methacrylate, 1,2,4-trivinylcyclohexane, or a combination thereof.

47. The method of claim 45 wherein the film has a dissipation factor of no greater than 0.0074.

48. The method of claim 45 wherein the film has a linear coefficient of thermal expansion of less than 52 ppm/degree Kelvin.

49. The method of claim 45 wherein the exposing to activating wavelengths of radiation is done in an imagewise manner and unexposed portions are removed prior to curing.

50. The method of claim 45 wherein the film has a reduced dissipation factor and or a reduced coefficient of linear thermal expansion as compared to films made with other cross-linkers.

51. An article made by the method of claim 45.

52. The article of claim 50 wherein the polyimide film is characterized by a dissipation factor of no greater than 0.0074, preferably less than 0.007, as determined by the Kent Method and a linear coefficient of thermal expansion of less than 52 ppm/degree Kelvin as determined by thermomechanical analysis.
